(19) United States
(12) Patent Application Publication
(10) Pub. No.: US 2002/0004394 A1
(43) Pub. Date: Jan. 10, 2002

(54) Roaming user overflow control system

(76) Inventors: Chen-Fang Tsai, Hsinchu Hsien (TW); Meng-Tzu Yen, Hsinchu (TW); Kuo-Pao Fan, Hsinchu (TW)

Correspondence Address: BIRCH STEWART KOLASCH & BIRCH, PO BOX 747, FALLS CHURCH, VA, 22040-0747, US

(21) Appl. No.: 09/814,857

(22) Filed: Mar. 23, 2001

(30) Foreign Application Priority Data
Jul. 6, 2000 (TW) 89113360

(51) Int. Cl. H04Q 7/20

(52) U.S. Cl. 455/432; 455/433; 455/435

(57) ABSTRACT

A method for controlling the overflow of roaming users in a public or private mobile communication system. When the number of roaming users is greater than the number of the roaming numbers in a specific region, a newly arriving roaming user is assigned the roaming number of an inactive roaming user already registered in the network, who becomes then an overflow roaming user. Should an overflow roaming user require the use of the mobile communication functions, for example to make or receive a call, the overflow roaming user is in turn assigned the roaming number of another inactive user, who then becomes an overflow user. By this method, a number of roaming numbers can be shuffled between a larger number of roaming users and roaming users arriving into a network with an overflow of roaming users are still able to access the mobile communication functions.

### BACKGROUND OF THE INVENTION

1. Field of the Invention

The present invention relates to a roaming user overflow control system for application in a mobile communications network, and more particularly relates to a roaming user overflow control system in which a roaming user can register in a roaming area when the number of the roaming users in that roaming area is greater than the number of roaming numbers available.

2. Description of the Prior Art

When the user of a mobile communications system moves out of the region of his or her home location register (HLR), the user is in a “roaming state.” At this time, the roaming user must be allocated a roaming number to access the mobile communication service in the roaming area. In conventional mobile communication systems which allocate roaming numbers on registration (e.g. TACS system), the user must register in the roaming area to obtain a roaming number. The allocation of roaming number in such conventional public and private mobile communication systems will now be described.

Public Mobile Communication System Which Allocates the Roaming Number On Registration

FIG. 1 shows a diagram of a conventional public mobile communication system (take TACS system for example). As shown in FIG. 1, when a roaming user 18 moves, the public mobile communication system traces the roaming user 18 by means of the home location register 10, 14 (HLR) and visitor location register 12, 16 (VLR). The main function of HLR 10, 14 is to track the HLR user, while the main function of VLR 12, 16 is to track the roaming users who enter the control area of VLR 12, 16. Therefore, HLR records the information, or profile, of a roaming user, while VLR records the location of the roaming user. When the roaming users wants to access the functions of the mobile communication system, for example dialing and call delivery, a mobile switching center 11,13 (MSC) is used. In FIG. 1, global location register 15, 17 (denoted as GLR) controls the MSC in the control area of the GLR.

When roaming user 18 goes out of the control area of HLR 10, the roaming user 18 is in a “roaming state.” At this time, the roaming user has to register to use the mobile communication system out of the control area of HLR 10. The process of registering and call delivery of a conventional public mobile communication system will now be described.

Refer to FIG. 2, which shows the flow chart of the registration process of the conventional public mobile communication system.

Step 101: roaming user 18 roams from home network A to network B.

Step 102: roaming user 15 delivers the register request to MSC 13.

Step 103: MSC 13 delivers the register request to VLR 16.

Step 104: VLR 16 provides a roaming number to the roaming user 18.

Step 105: VLR 16 notifies HLR 10 that the roaming number of the roaming user 18 in network B.

Step 106: HLR 10 stores the roaming number of the roaming user.

Refer to FIG. 3, which shows the flow chart of the call delivery process of the conventional public mobile communication system.

Step 201: when another user dials the telephone number of the roaming user 18, the call request is connected to GMSC 15 of the home network A.

Step 202: GMSC 15 asks HLR 10 to provide the routing information of the roaming user 18.

Step 203: HLR 10 delivers the roaming number, which is stored in advance, to GMSC 15.

Step 204: GMSC 15 connects to GMSC 17 that controls roaming user 18.

Step 205: GMSC 17 asks VLR 16 to provide more detailed routing information of the roaming user 18.

Step 206: VLR 16 provides GMSC 17 the routing information of the roaming user 18.

Step 207: GMSC 17 finishes the operation of connecting to the roaming user 18.

Accordingly, the conventional public mobile communication system must provide a roaming number to the roaming user who requests to register. Even if the roaming user doesn't use the communication functions, the roaming user still has to keep the roaming number. Therefore, the conventional public mobile communication system must provide roaming numbers corresponding to all the roaming users. If there are not enough roaming numbers, subsequently arriving roaming users cannot register to use the communication functions. However, in practical application, most roaming users are not using the communication functions at any given moment. Thus, assigning each roaming user a roaming number at all times is a waste of roaming numbers. Furthermore, a large number of roaming numbers are necessary to maintain the operability of the system, thus increasing cost.

Private Mobile Communication System Which Allocates the Roaming Number When the User Register

Refer to the FIG. 4, which shows a diagram of the conventional private mobile communication system. While a private mobile communication system may have more than two zones, two zones are used in this example.

As shown in FIG. 4, PBX is a switching center in a firm. Different firms can be connected by a Public Switched Telephone Network (PSTN hereinafter) or a special telephone line. A mobility manager (MM hereinafter), a base station (BS hereinafter), and a mobile telephone enable wireless mobile communication. MM provides the connections between the mobile telephones, and provides the connections between the mobile telephone and the wire network and PSTN by PBX. There are two interfaces between MM and PBX, such as line interface (like T/R) and trunk interface (like R₂/E₁) . When the MM and the PBX are connected by the line interface, the mobile telephone is considered an extension of PBX, so the supplementary service is controlled by the PBX. When the MM and PBX are connected by a trunk interface, the mobile telephone is considered an extension of the MM, so the supplementary service (like unconditional can forward) is controlled by the MM. Moreover, the MMs in the different zones can be connected by a digital network for transmitting the information.

When a roaming user moves from home network C to zone D or zone E, the roaming user is considered in a “roaming” state. In the private mobile communication system, PBX provides the roaming numbers, which are controlled by the MM. MM comprises the home location register, visitor location register, and a part of the mobile switching center, etc.

Refer to FIG. 5, which shows the flow chart of the registration process of the conventional private mobile communication system.

Step 301: roaming user 20 delivers a register request to MM 23 when roaming from home zone C to zone E.

Step 302: MM 23 stores the register information of roaming user 20 and provides a roaming number RN1 for roaming user 20.

Step 303: MM 23 delivers the register information to notify MM 21 that the roaming user 20 has roamed to zone E and roaming user's roaming number is RN1.

Step 304: when MM 21 receives the register information, M21 implements the information of the user 20 according to the interface of the home zone C.

a. if the roaming user uses the trunk interface, MM 21 stores the routing information of the roaming user 20, wherein the routing information at least comprises the roaming number RN1 and the zone E.

b. if the roaming user uses the line interface, MM 21 stores the routing information of the roaming user 20 and changes the unconditional can forward number of PBX 25 to RN1, wherein the routing information at least comprises the roaming number RN1 and the zone E.

Step 305: MM 21 delivers the register acknowledge message to inform MM 23 that it has received the information that the roaming user 20 has moved to zone E, wherein the register message further comprises the profile of the user.

Step 306: when MM 23 receives the register acknowledge message, MM 23 responds that the roaming user 23 is done with the register request.

Refer to FIG. 6, which shows the flow chart of the registration cancellation process of the conventional private mobile communication system.

Step 401: if the roaming user 20 roams to zone D, MM 21 has to notify MM 23 to cancel the roaming number and the profile of the roaming user 20. So MM 21 delivers the registration cancellation message to notify MM 23 the roaming user has left zone D.

Step 402: MM 23 delivers the cancel acknowledge to MM 21.

Refer to FIG. 7, which shows the flow chart of the call delivery process of the conventional private mobile communication system.

Step 501: a telephone user dials the telephone number of the roaming user 20.

Step 502:

a. if the roaming user uses the line interface, because the unconditional can forward number is set to RN1, PBX 25 connects to PBX 27 by RN1.

b. if the roaming user uses the trunk interface, MM 21 checks the profile of the roaming user 20, and asks PBX 25 to connect to PBX 27 by RN1.

Step 503: PBX 27 receives the call request of the PBX 25.

a. if the interface is line, PBX 27 rings the line, and the ring will be detected by MM 23.

b. If the interface is trunk, PBX 27 performs the call request with M23 by signaling.

STEP 504: when MM 23 detects the ring or receives the signaling request, the roaming user 20 and the dialing user are connected.

Like the conventional public mobile communication system, the conventional private mobile communication system must provide roaming numbers corresponding to all the roaming users. Because the roaming numbers of PBX are limited, an accumulation of users in a specific zone can lead to the situation where late coming roaming users in the specific zone cannot register because there are not enough roaming numbers, and thus cannot use the mobile communication functions. This might occur, for example, when an activity causes a large number of users to gather at one location.

### SUMMARY OF THE INVENTION

The object of the present invention is to provide a method for controlling the overflow of roaming users in a public or private mobile communication system. The method of this invention provides that when the number of roaming users is greater than the number of the roaming numbers in a specific region, a new roaming user arriving in the region is still able to register and use the mobile communication functions.

In the case of an overflow of roaming users in a specific network of a public or private mobile communication system, there are not enough roaming numbers for every roaming user. However, at any given time, most roaming users are not utilizing the mobile communication functions. Thus, at any given time, a large number of the registered roaming numbers are inactive. The present invention takes advantage of this situation by providing a method of registering users in which a newly arriving roaming user is assigned the roaming number of an inactive roaming user already registered in the network, who becomes then an overflow roaming user. Should an overflow roaming user require the use of the mobile communication functions, for example to make or receive a call, the overflow roaming user is in turn assigned the roaming number of another inactive user, who then becomes an overflow user. By this method, a number of roaming numbers can be shuffled between a larger number of roaming users. Thereby, roaming users arriving into a network with an overflow of roaming users are still able to access the mobile communication functions. Furthermore, the cost of the system can be decreased because fewer roaming numbers are needed to serve the same number of roaming users.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 shows a diagram of the conventional public mobile communication system.

FIG. 2 shows the flow chart of the registration process of the conventional public mobile communication system.

FIG. 3 shows the flow chart of the call delivery process of the conventional public mobile communication system.

FIG. 4 shows a diagram of the conventional private mobile communication system.

FIG. 5 shows the flow chart of the registration process of the conventional private mobile communication system.

FIG. 6 shows the flow chart of the registration cancellation process of the conventional private mobile communication system.

FIG. 7 shows the flow chart of the call delivery process of the conventional private mobile communication system.

FIG. 8 shows a diagram of the public mobile communication system according to the first embodiment of the present invention.

FIG. 9 shows the flow chart of the overflow registration process of the public mobile communication system according to the first embodiment of the present invention.

FIG. 10 shows a diagram of the public mobile communication system according to one example of the first embodiment of the present invention.

FIG. 11 shows the flow chart of the overflow call delivery process of the public mobile communication system according to the first embodiment of the present invention.

FIG. 12 shows a diagram of the private mobile communication system according to the second embodiment of the present invention.

FIG. 13 shows the flow chart of the overflow registration process of the private mobile communication system according to the second embodiment of the present invention.

FIG. 14 shows the flow chart of the overflow call delivery process of the private mobile communication system according to the second embodiment of the present invention.

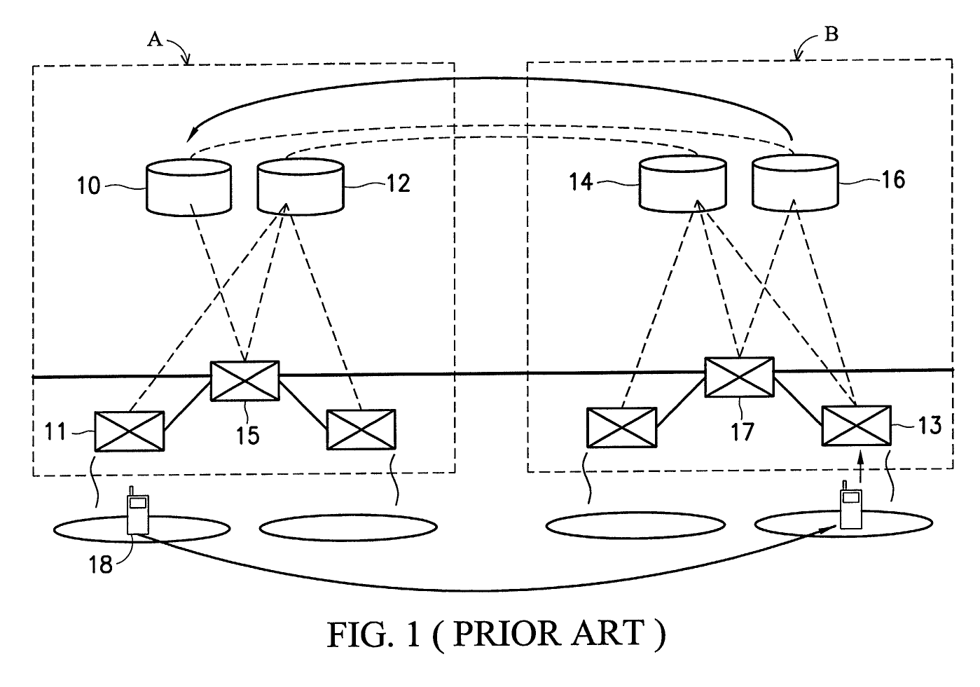

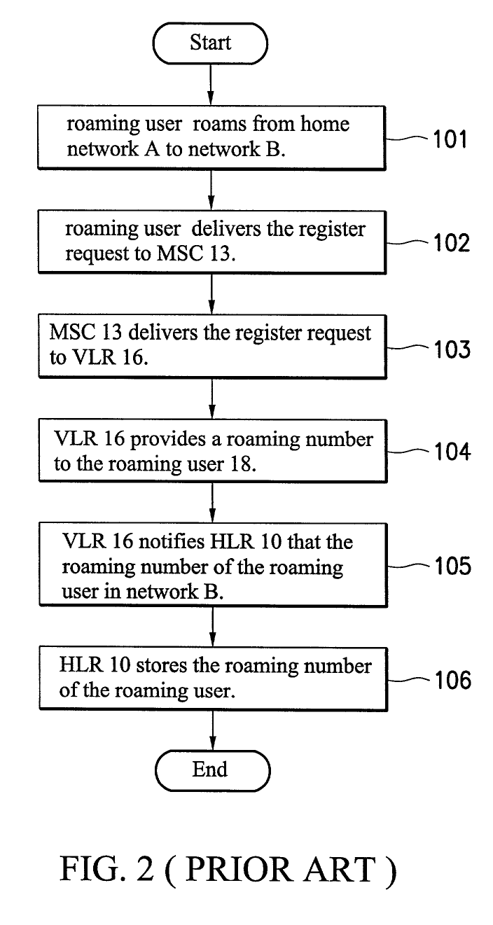

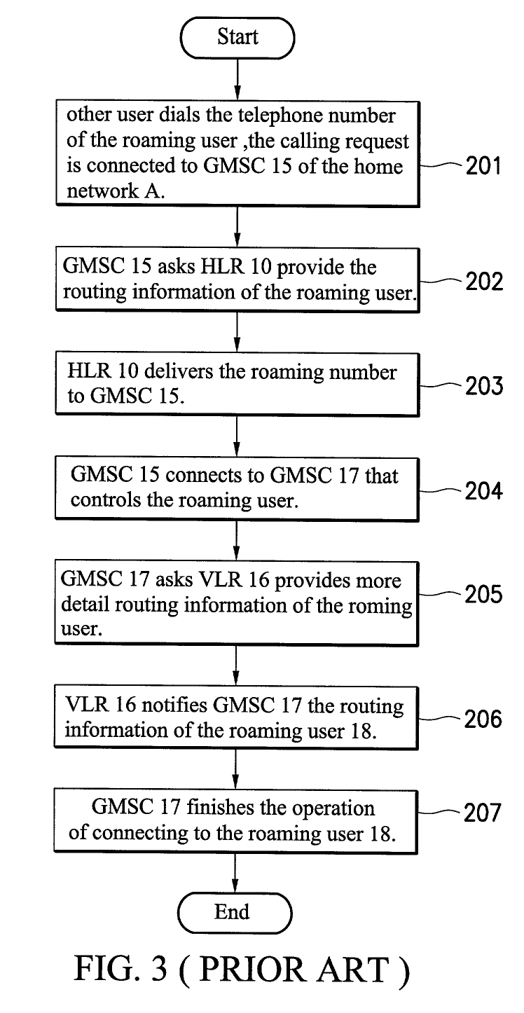

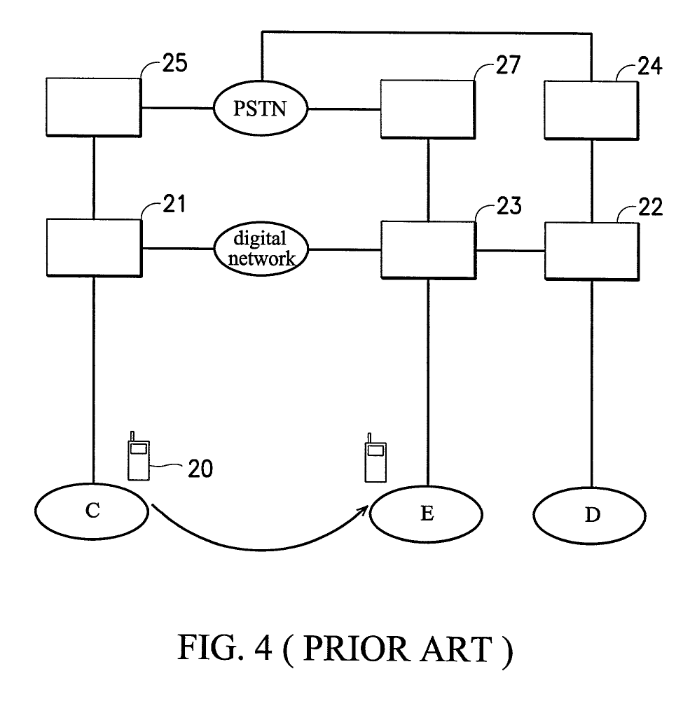

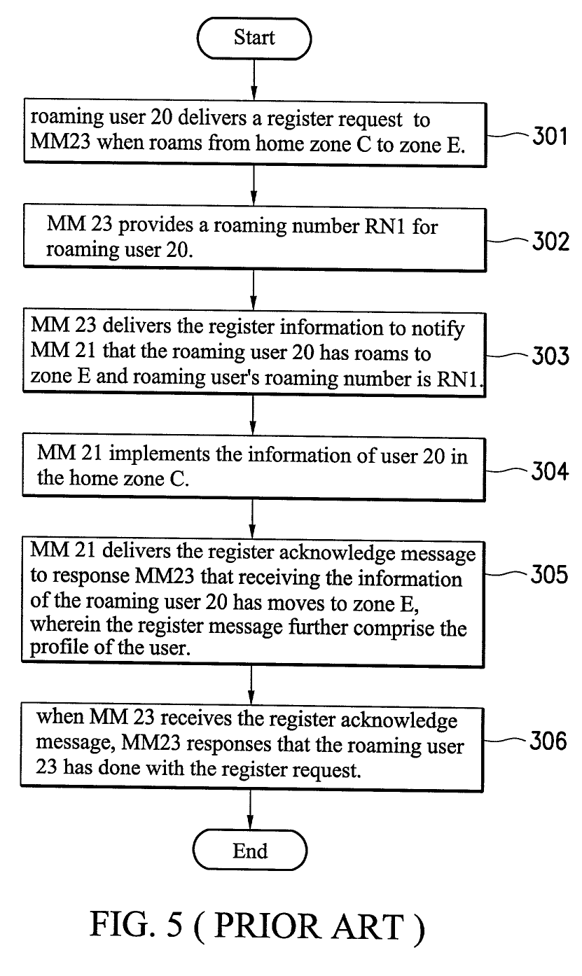

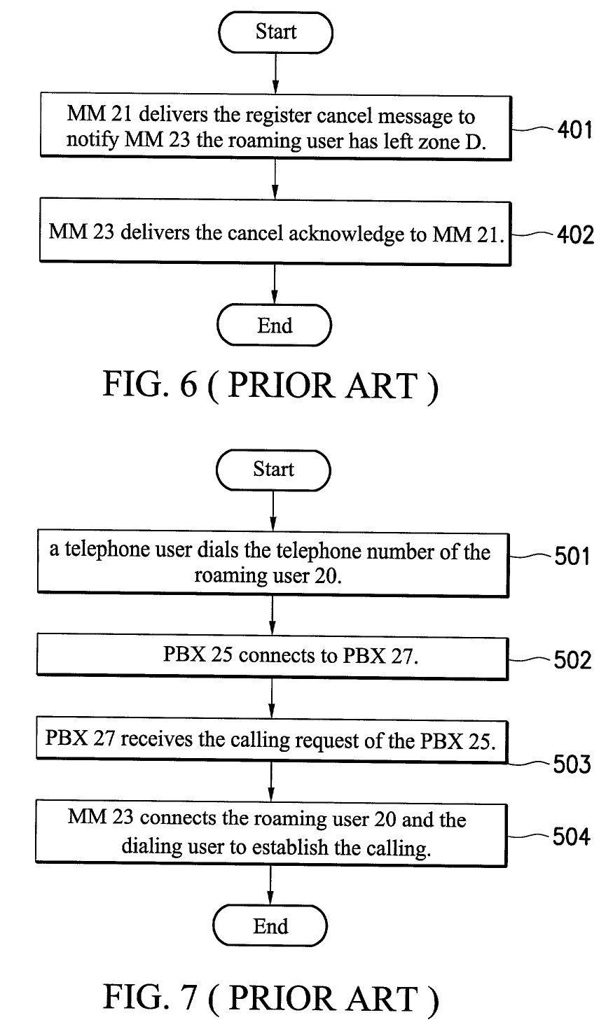

### DETAILED DESCRIPTION OF THE INVENTION

The present invention provides a method for controlling the overflow of roaming users in a mobile communication system. The method can be applied to any mobile communication system in which roaming numbers are allocated to roaming users before the users access mobile communication functions such as call delivery (e.g., the TACS system). The first embodiment applies the method of the invention to a public mobile communication system, while the second embodiment applies the method of the invention to a private mobile communication system. However, it is understood that this is not intended to limit the scope of the present invention.

First Embodiment

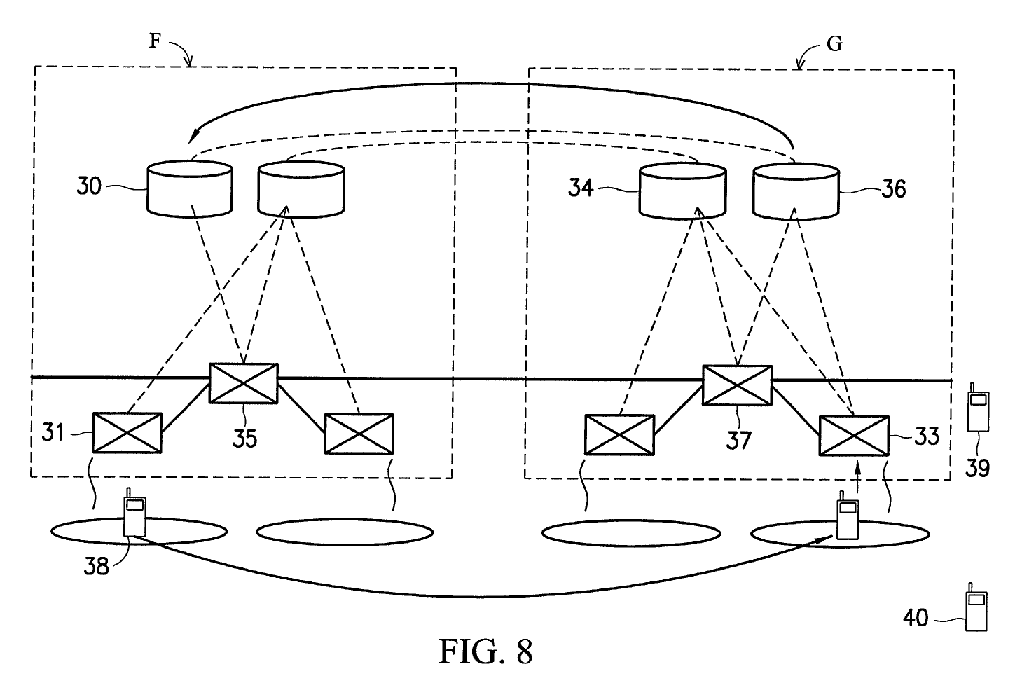

FIG. 8 shows a diagram of the public mobile communication system according to the first embodiment of the present invention.

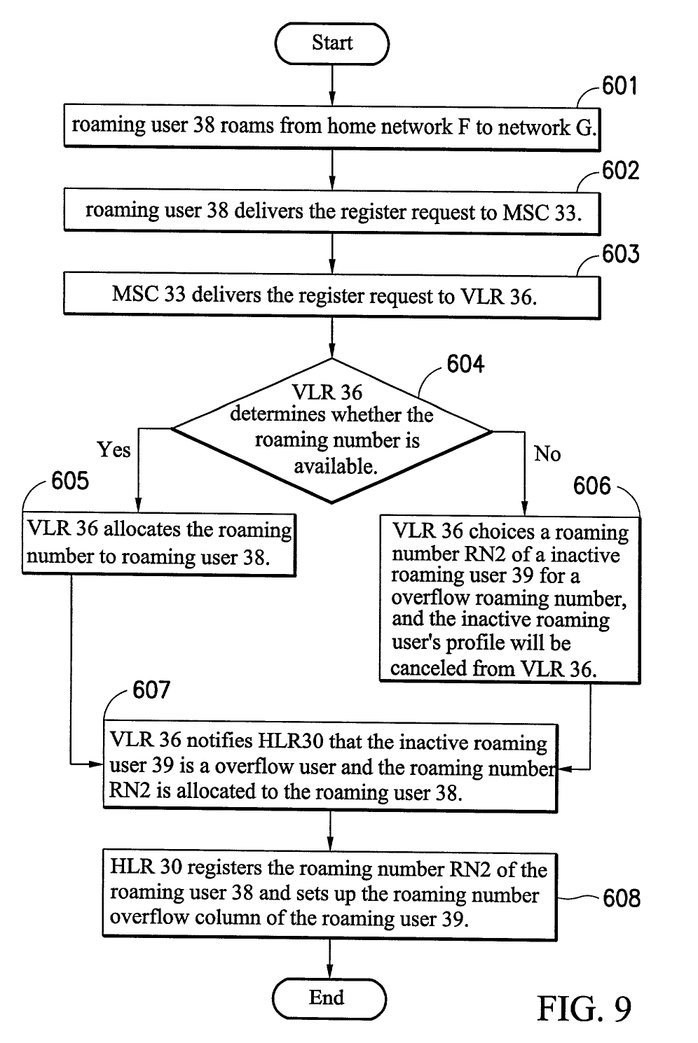

Moreover, FIG. 9 shows the flow chart of the overflow registration process of the public mobile communication system according to the first embodiment of the present invention.

Step 601: roaming user 38 roams from home network F to network G.

Step 602: roaming user 38 delivers the register request to MSC 33.

Step 603: MSC 33 delivers the register request to VLR 36.

Step 604: VLR 36 determines whether a roaming number is available. If a roaming number is available, go to the Step 605, wherein VLR 36 allocates the roaming number to roaming user 38. If there are no roaming numbers available, go to the Step 606, wherein VLR 36 assigns a roaming number RN2 of an inactive roaming user 39 to roaming user 38. Inactive roaming user 39 becomes an overflow roaming user, and the inactive roaming user's profile is canceled from VLR 36. The selection of the inactive roaming user 39 can be based on the longest period of inactivity, the earliest registration, random selection, or any other appropriate method.

Step 607: VLR 36 notifies HLR 30 that the roaming user 39 is an overflow user and the roaming number RN2 is allocated to the roaming user 38.

Step 608: HLR 30 registers the roaming number RN2 of the roaming user 38 and sets up the roaming number overflow column of the roaming user 39.

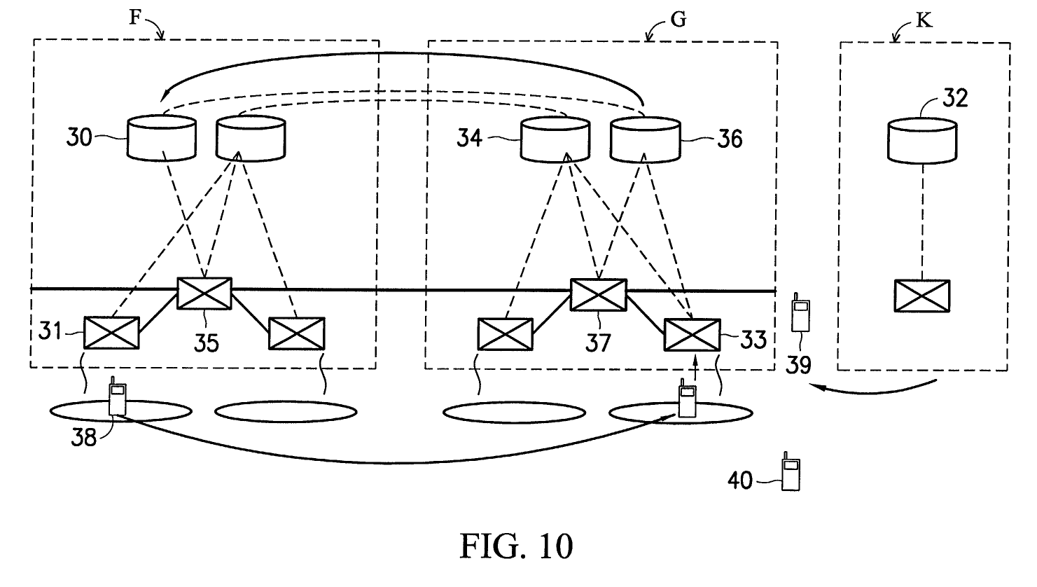

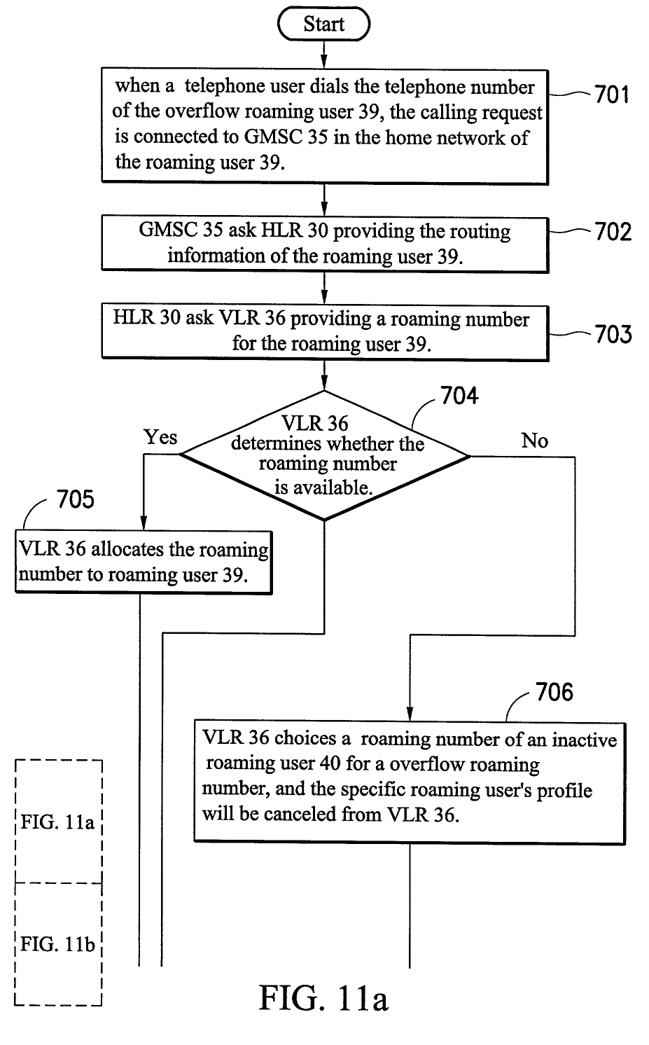

It is possible that roaming user 38 and roaming user 39 do not come from the same home network. FIG. 10 shows a diagram of the public mobile communication system according where roaming user 38 comes from home network F while roaming user 39 comes from home network K. In this case, in Step 607, VLR 36 notifies HLR 30 that the roaming number RN2 is allocated to the roaming user 38 and notifies HLR 32 in network K that the roaming user 39 is an overflow user. In Step 608, HLR 32 sets up the roaming number overflow column of the roaming user 39.

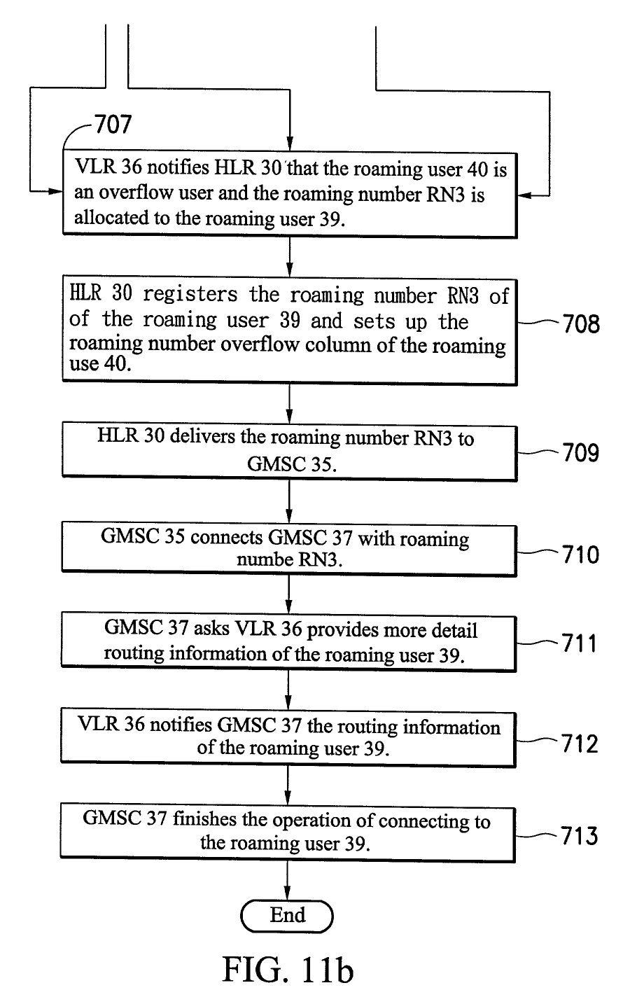

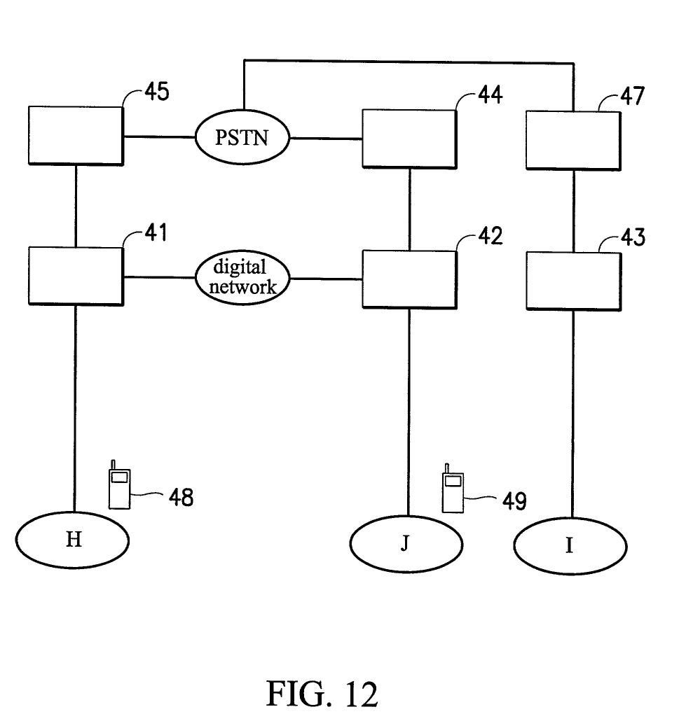

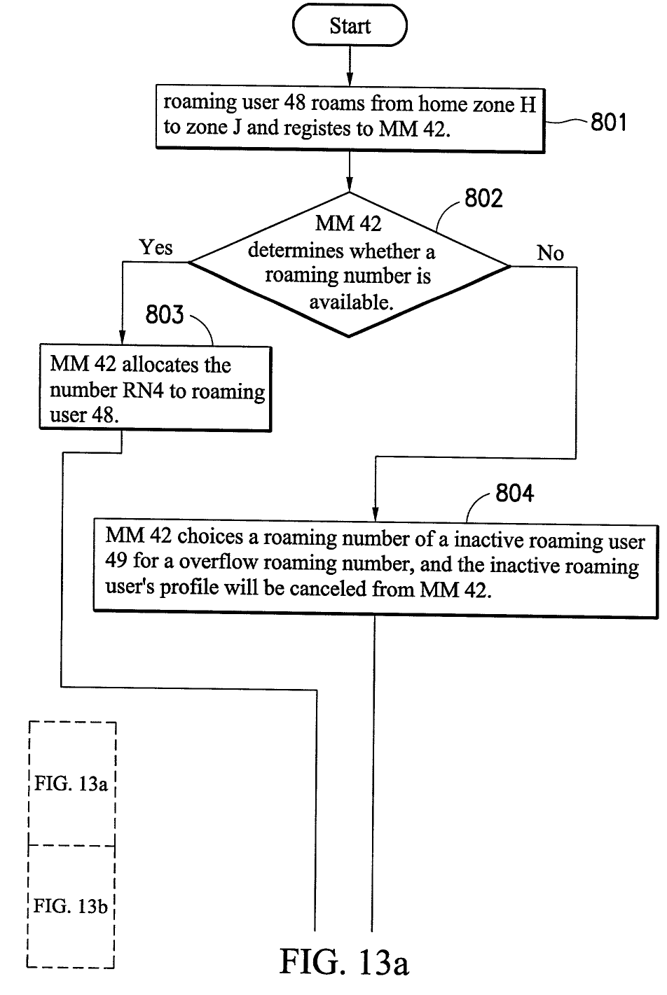

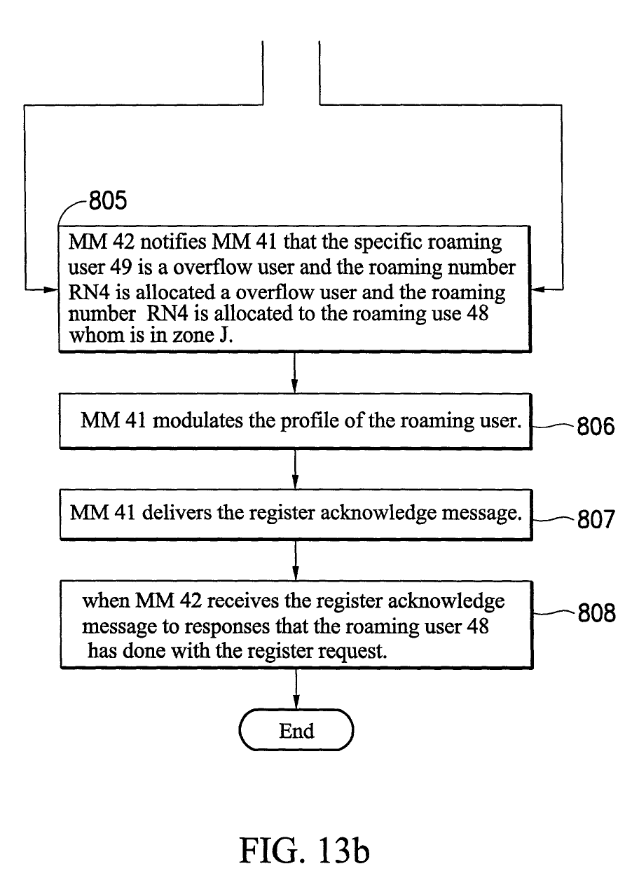

As described above, the method of this invention assigns the roaming number of an inactive roaming user to a newly arriving roaming user. The inactive roaming user then becomes an overflow roaming user. Should the overflow roaming user require the use of the mobile communication functions, for example to make or receive a call, the overflow roaming user must be re-registered. The following describes the situation where overflow roaming user 39 receives a telephone call, wherein FIG. 11 shows the flow chart of the overflow user call delivery process of the public mobile communication system according to the first embodiment of the present invention. In this example, network F is the home network of roaming user 39 and roaming user 40.

Step 701: when a telephone user dials the telephone number of the overflow roaming user 39, the call request is connected to GMSC 35 in the home network of the roaming user 39.

Step 702: GMSC 35 asks HLR 30 to provide the routing information of the roaming user 39.

Step 703: HLR 30 asks VLR 36 to provide a roaming number for the roaming user 39.

Step 704: VLR 36 determines whether a roaming number is available. If a roaming number is available, go to the Step 705, wherein VLR 36 allocates the roaming number to roaming user 39. If there are not roaming number available, go to the Step 706, VLR 36 assigns a roaming number RN3 of an inactive roaming user 40 to roaming user 39. Inactive user 40 becomes an overflow roaming user, and the inactive roaming user's profile is canceled from VLR 36. The selection of the inactive roaming user 40 can be based on the longest period of inactivity, the earliest registration, random selection, or any other appropriate method. As can be seen, inactive roaming user 40 takes the place of roaming user 39 as an overflow roaming user.

Step 707: VLR 36 notifies HLR 30 that the roaming user 40 is an overflow user and the roaming number RN3 is allocated to the roaming user 39.

Step 708: HLR 30 registers the roaming number RN3 of the roaming user 39 and sets up the roaming number overflow column of the roaming user 40.

As described above, if the roaming user 39 and the roaming user 40 belong to different networks (for example, if roaming 39 belongs to home network F while roaming user 40 belongs to home network K), in Step 607, VLR 36 notifies HLR 30 that the roaming number RN3 is allocated to the roaming user 39 and notifies HLR 32 in network K that the roaming user 40 is an overflow user. In Step 608, HLR 32 sets up the roaming number overflow column of the roaming user 40.

Step 709: HLR 30 delivers the roaming number RN3 to GMSC 35.

Step 710: GMSC 35 connects GMSC 37 with roaming number RN3.

Step 711: GMSC 37 asks VLR 36 provides more detail routing information of the roaming user 39.

Step 712: VLR 36 notifies GMSC 37 the routing information of the roaming user 39.

Step 713: GMSC 37 finishes the operation of connecting to the roaming user 39.

As long as the number of the roaming users being called at the same time does not exceed the number of roaming users of the VLR 36, the system can handle all of the roaming users with a smaller number of roaming numbers. Thus, the efficiency of the present invention is better than the prior art. By the method according to the present invention, the performance of a conventional system can be improved with without upgrading the hardware.

Second Embodiment

FIG. 8 shows a diagram of the private mobile communication system according to the second embodiment of the present invention.

The roaming numbers available in a specific zone of a PBX are limited. If there are some activity causing users to gather to in a specific zone, the specific zone will not have enough roaming numbers. Thus, roaming users in the specific zone cannot register, and cannot use the mobile communication functions. The second embodiment of the present invention provides a method to control the overflow roaming numbers to higher the performance of the private mobile communication system.

FIG. 9 shows the flow chart of the overflow registration process of the private mobile communication system according to the second embodiment of the present invention.

Step 801: roaming user 48 roams from home zone H to zone J and registers to MM 42.

Step 802: MM 42 determines whether a roaming number is available. If a roaming number is available, go to the Step 803, wherein MM 42 allocates the roaming number RN4 to roaming user 48. If there are no roaming numbers available, go to the Step 804, wherein MM 42 assigns a roaming number of an inactive roaming user 49 to roaming user 48, wherein the inactive roaming user 49 becomes an overflow roaming user and the inactive roaming user's profile is canceled from MM 42. The selection of the inactive roaming user 49 can be based on the longest period of inactivity, the earliest registration, random selection, or any other appropriate method.

Step 805: MM 42 notifies MM 41 that the inactive roaming user 49 is an overflow user and the roaming number RN4 is allocated to the roaming user 48 whom is in zone J.

Step 806: MM 41 updates the routing information and the roaming number of the roaming user 48, sets up roaming number overflow column of the roaming user 49, stores the routing information of the roaming user 48 and changes the unconditional diverted number to RN4 as in Step 304, and cancels the set of the unconditional diverted number of user 49.

Step 807: MM 41 delivers the registration acknowledged message to MM 42 indicating the MM 41 has received the information that the roaming user 20 has moved to zone J, wherein the message further comprises the profile of the user.

Step 808: when MM 42 receives the registration acknowledged message, MM 42 responds that the roaming user 48 has completed the registration request.

In Step 802, if the user 48 and the user 49 are from different zone (e.g., the home zone of the user 49 is zone I), MM 42 notifies MM 41 that the roaming number RN4 is allocated to the roaming user 48 whom is in zone J and notifies MM 43 that the inactive roaming user 49 is an overflow user. Moreover, in Step 806, MM 41 updates the routing information and the roaming number of the roaming user 48, stores the routing information of the roaming user 48 and changes the unconditional diverted number to RN4, while MM 43 sets up roaming number overflow column of the roaming user 49, and cancels the set of the unconditional diverted number of user 49 as in Step 304.

The following described the situation wherein the telephone number of the roaming user 48, who is an overflow user, is dialed.

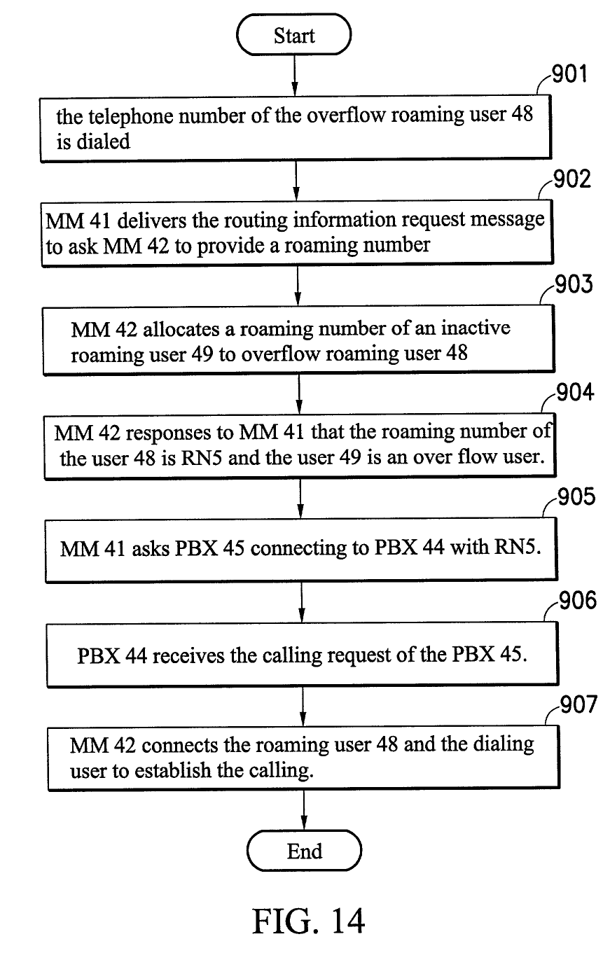

Refer to FIG. 14, which shows the flow chart of the overflow call delivery process of the private mobile communication system according to the second embodiment of the present invention.

Step 901: the telephone number of the overflow roaming user 48 is dialed, wherein the telephone number is the extension number of the roaming user 48 in zone H.

Step 902: MM 41 delivers the routing information request message to ask MM 42 to provide a roaming number, wherein the routing information request message further comprises the user profile of the overflow roaming user 48.

Step 903: MM 42 allocates a roaming number of an inactive roaming user 49 to overflow roaming user 48, wherein the inactive roaming user becomes an overflow user and the inactive roaming user's profile is canceled from MM 42. The selection of the inactive roaming user 49 can be based on the longest period of inactivity, the earliest registration, random selection, or any other appropriate method.

Step 904: MM 42 responds to MM 41 that the roaming number of the user 48 is RN5 and the user 49 is an overflow user. MM 42 further updates the user information and sets up the divert information.

Step 905: MM 41 asks PBX 45 connecting to PBX 44 with RN5.

Step 906: PBX 44 receives the call request of the PBX 45.

a. if the interface is line, PBX 44 rings the line, and the ring will be detected by MM 42.

b. If the interface is trunk, PBX 44 performs the call request with M42 by signaling.

Step 907: when MM 42 detects the ring or receives the signaling request, connects the roaming user 48 and the 5 dialing user to establish the calling.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for controlling the overflow of roaming users in a mobile communication system having at least a first roaming user roaming from a home network having at least a first mobile switching center to a visitor network having a plurality of roaming users having a plurality of roaming numbers, a visitor location register and a second mobile switching center, the method comprising the steps of:
transmitting a registration request from the first roaming user second mobile switching center;
delivering the registration request from the second mobile switching center to the visitor location register;
determining whether a roaming number is available in the visitor location register, wherein if a roaming number is available, the visitor location register allocates the roaming number to the first roaming user, and if not, the visitor location register allocates the roaming number of a first inactive roaming user selected from the plurality of roaming users to the first roaming user, wherein the first inactive roaming user becomes a first overflow roaming user; and
transmitting from the visitor location register to the home location register the allocated roaming number of the first roaming user and a user ID of the first overflow roaming user.

2. The method for controlling the overflow of users as claimed in claim 1, wherein, when communicating with the first overflow roaming user, the following steps are taken:
transmitting a request from the first mobile switching center to the home location register to provide the routing information of the first inactive roaming user;
transmitting a request from the home location register to the visitor location register to provide a roaming number for the first overflow user;
determining whether a roaming number is available in the visitor location register, wherein if a roaming number is available, the visitor location register allocates the roaming number to the first overflow roaming user, and if not, the visitor location register allocates a the roaming number of a second inactive user to the first overflow roaming user, and the second inactive user becomes a second overflow roaming user;
transmitting from the visitor location register to the home location register the allocated roaming number of the first overflow roaming user and a user ID of the second overflow roaming user;
transmitting from the home location register to the first mobile switching center the allocated roaming number of the first overflow roaming user;
connecting the first mobile switching center and the second mobile switching center by the allocated roaming number; and
communicating with the first overflow roaming user by way of the second mobile switching center.

3. The method for controlling the overflow of roaming number of mobile communication system as claimed in claim 2, wherein the first and second inactive roaming user are inactive on the basis of the longest period of inactivity.

4. The method for controlling the overflow of roaming number of mobile communication system as claimed in claim 2, wherein the first and second inactive roaming user are selected based on earliest registration.

5. The method for controlling the overflow of roaming number of mobile communication system as claimed in claim 2, wherein the first and second inactive roaming user are selected randomly.

6. A method for controlling the overflow of roaming users in a mobile communication system having a first roaming user roaming from a home network having at least a first mobility manager to a visitor network having a plurality of roaming users having a plurality of roaming numbers and a second mobility manager, the method comprising the steps of:
transmitting a registration request to the second mobility manager for the first roaming user;
determining whether a roaming number is available in the second mobility manager, wherein if a roaming number is available, the second mobility manager allocates the roaming number to the first roaming user, if not, the second mobility manager allocates the roaming number of a first inactive roaming user to the first roaming user, and the first inactive user becomes a first overflow roaming user; and
delivering the allocated roaming number of the first roaming user and a user ID of the first overflow roaming user from the first mobility manager to the second mobility manager.

7. The method for controlling the overflow of roaming users as claimed in claim 6, wherein, when communicating with the first overflow roaming user, the following steps are taken:
transmitting a request from the first mobility manager to the second mobility manager to provide the routing information of the first inactive roaming user;
determining whether a roaming number is available in the second mobility manager, wherein if a roaming number is available, the second mobility manager allocates the roaming number to the first overflow roaming user, and if not, the second mobility manager allocates a roaming number of a second inactive user to the first overflow roaming user, and the second inactive user becomes a second overflow roaming user; and
transmitting from the second mobility manager to the first mobility manager the delivering the allocated roaming number of the first overflow roaming user and a user ID of the second overflow roaming user.

8. The method for controlling the overflow of roaming number of mobile communication system as claimed in claim 7, wherein the first and second inactive roaming user are selected based on the longest period of inactivity.

9. The method for controlling the overflow of roaming number of mobile communication system as claimed in claim 7, wherein the first and second inactive roaming user are selected based on the earliest registration.

10. The method for controlling the overflow of roaming number of mobile communication system as claimed in claim 7, wherein the first and second inactive roaming user are selected randomly.
